(19) United States
(12) Patent Application Publication
(10) Pub. No.: US 2013/0114773 A1
(43) Pub. Date: May 9, 2013

(54) SUPERCONDUCTING NEUTRON SOURCE

(71) Applicants: Alexander R. Vaucher, Chino Hills, CA (US); Kevin S. McKinny, Hudson, OH (US)

(72) Inventors: Alexander R. Vaucher, Chino Hills, CA (US); Kevin S. McKinny, Hudson, OH (US)

(21) Appl. No.: 13/291,559

(22) Filed: Nov. 8, 2011

(51) Int. Cl. G21B 1/00

(52) U.S. Cl. 376/112

(57) ABSTRACT

A superconducting neutron source and a method for producing a high intensity, high energy neutron beam having a narrow beam width. A pair of beam extraction electrodes are located in a vacuum vessel of a cyclotron. The electrodes deflect a pair of deuteron beams from a stream of ionized deuterium gas swirling within the vacuum vessel. The deuteron beams are extracted from the cyclotron and funneled through a superconducting beam focusing tube. The beams are focused by the superconducting tube so as to move towards and collide with one another within the tube. A narrow neutron beam is obtained by colliding staggered deuteron beams moving in the same direction so that the momentum of the colliding beams is retained.

### BACKGROUND OF THE INVENTION

1. Field of the Invention

The invention relates to a superconducting neutron source and to a method for producing a high intensity, high energy neutron beam having a relatively narrow beam width. A pair of deuteron beams traveling in the same (i.e., forward) direction are extracted from a cyclotron and funneled through a superconducting focusing tube where the deuteron beams collide to generate a high fluence of neutrons also traveling in the forward direction.

2. Background Art

The use of neutrons in science and technology has found increasing applications in recent years. Neutrons can be obtained from radioactive sources, sealed source portable generators, or from nuclear power reactors. Most sealed source devices utilize a DT reaction to produce neutrons. The Kinematics of this reaction produce neutrons at 14 MeV. Most commonly used radioactive sources produce neutrons in the 2.5 to 5 MeV range, while power reactors are mostly used for irradiation with thermal neutrons. All of these sources produce neutrons having a 4π solid angle profile. While a narrower beam can be obtained by using adequate shielding, the neutron flux is greatly reduced.

There are a variety of conventional techniques in use for producing neutrons, such as, for example:
1. Radioactive sources emitting neutrons: ²⁵²Cf, 1 mg emits approximately 2.3×10⁹ neutrons per second with average energy of 2.1 MeV.
2. Americium-Beryllium sealed source: uses ²⁴¹Am as a source of alpha particles to bombard Be thus producing neutrons. Emits approximately 2.2×10⁶ neutrons per second. Working lifetime about 15 years.
3. Deuterium-Deuterium fixed target sealed tube: produces up to 2×10¹¹ neutrons per second with an average energy of 2.5 MeV.
4. Deuterium-Tritium fixed target sealed tube: produces up to 2×10¹³ neutrons per second with an average energy of 14 MeV.
5. Proton accelerator on Lithium fixed target: up to 1×10¹³ neutrons per second with an average energy of 2.5 MeV.
6. Fission from Nuclear Reactor: up to 1×10¹⁵ neutrons per second. The average neutron energy is about 2.0 MeV, but about 200 MeV per neutron must be dissipated as heat. The neutrons must be moderated (slowed) to be useful with thermal energies down to 0.025 eV. The cost of using neutrons from a nuclear reactor in prohibitive.
7. Spallation Sources: High energy protons (1000 MeV) on a fixed heavy thick target such as ²³⁸U will produce neutrons with an average energy of 2.0 MeV and with about 30 MeV of energy dissipated as heat. Neutron yield varies with the type of the fixed target. 1000 MeV protons on a ²³⁸U target produces about 40 neutrons per incident proton. The neutrons must be moderated to be useful.
8. Particle accelerators can be used to obtain neutrons with energies of 50 MeV or higher using protons on light nuclei such as Deuterium in a fixed target. The proton energies required are 650 to 800 MeV.

In all of these cases, the neutrons are produced by a collision with a fixed target. The greatest disadvantage of such a collision is that the neutrons are generally scattered in all directions. The number of neutrons is divided on a sphere (or 4π solid angle). Thus, the only way to increase intensity on target, or part of the sphere, is to increase the number of neutrons produced overall. The cost of generating neutrons from nuclear reactors, spallation sources, and particle accelerators is prohibitive, with construction costs greater than $1.5 billion and operating costs greater than $140 million annually.

Neutron sources 1-4 described above can be made portable, but the neutron energy is limited. Neutron sources 5-8 described above require large facilities and are not portable.

### SUMMARY OF THE INVENTION

A method and an apparatus are disclosed for producing neutrons in a DD reaction using two colliding deuteron beams traveling in the same direction, but staggered in time and energy. The leading (slower) beam is the “target” beam, and the staggered (or incident) beam follows with a higher energy offset to maximize neutron yield. The result of this collision produces neutrons with much of the forward momentum of the colliding beams, thus a narrow beam of neutrons is produced.

According to the preferred embodiment, a cyclotron is provided with a pair of high voltage, negatively-charged beam extraction electrodes which are spaced outwardly from one another with respect to an ion source. The ion source generates an ionized deuterium gas stream which moves in a helical path outwardly towards the electrodes. A first of the pair of beam extraction electrodes deflects the leading or target deuteron beam having a relatively low velocity and energy. The second of the electrodes deflects the incident deuteron beam with a velocity and energy that are higher than those of the target beam.

The staggered target and incident deuteron beams are extracted from the cyclotron at an extraction port thereof and funneled down a superconducting beam focusing tube. The beam focusing tube is enclosed by a cryostat vacuum container that is filled with a cryogenic liquid coolant. The faster moving incident deuteron beam will catch up to and collide with the slower moving target deuteron beam. An inner wall of the beam focusing tube that is manufactured from a high temperature superconductor functions as a focusing lens to push the deuteron beams towards one another. Accordingly, the incident beams are maintained at high energy. At the point of collision within the beam focusing tube, both the incident and target beams are traveling in the same (i.e., forward) direction. By staggering and then funneling two deuteron beams differing in energy, the resulting neutrons carry much of the momentum of the colliding beams which leads to forward scattering.

### BRIEF DESCRIPTION OF THE DRAWINGS

FIG. 1 is a top view of a cyclotron to generate a pair of (incident and target) deuteron beams for producing a high intensity, high energy neutron beam;

FIG. 2 is a graphical representation of the energy required for the maximum production of neutrons from a DD reaction;

FIG. 3 is a side view of the cyclotron shown in FIG. 1;

FIG. 4 is a top view of a superconducting beam focusing tube according to a preferred embodiment to be coupled to the cyclotron of FIGS. 1 and 2 so that the pair of deuteron beams generated by the cyclotron can be funneled down the beam focusing tube within which to collide with one another;

FIG. 5 is a side view of the superconducting beam focusing tube shown in FIG. 3;

FIG. 6 is graphical representation to illustrate the distance to the collision of the pair of deuteron beams within the superconducting beam focusing tube of FIGS. 3 and 4 depending upon the energy difference between the beams; and

FIG. 7 is a graphical representation of neutron angular distribution in a lab frame from DD collisions with 2.0 MeV relative energy.

### DESCRIPTION OF THE PREFERRED EMBODIMENT

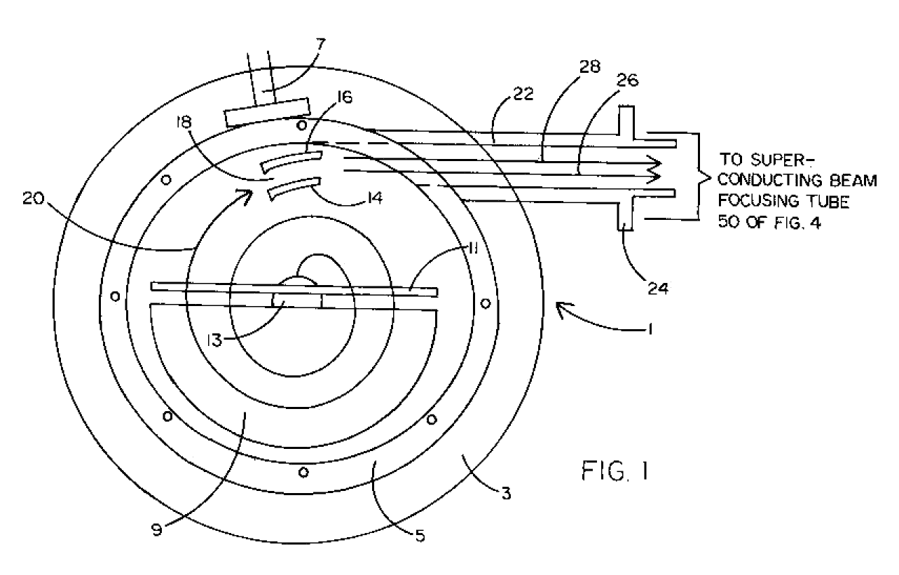

Referring to FIG. 1 of the drawings, there is shown a top view of a preferred embodiment for a superconducting cyclotron 1 that is particularly useful in a method for generating a high intensity, high energy neutron beam. The cyclotron 1 includes an outer cylindrical superconducting coil cryostat 3. Located between and surrounded by the coil cryostat 3 is an inner (e.g., stainless steel) cylindrical vacuum vessel housing 5 that is adapted to sustain a vacuum. A vacuum port 7 communicates with the interior of the housing 5 so that a vacuum can be drawn therewithin. Located inside the vacuum vessel housing 5 is a single (e.g., brass) DEE electrode 9. The electrode 9 has a hollow, generally D-shaped configuration. Spaced from the electrode 9 is a hollow, rectangular DDE electrode 11, sometimes referred to as a “dummy” electrode. An ion source 13 (e.g., a Penning ion generator) extends between the DEE electrode 9 and the dummy electrode 11.

The ion source 13 is located at the approximate center of the vacuum vessel housing 5. A pair of high voltage, negatively-charged beam extraction electrodes 14 and 16 are separated from one another by a gap 18. The beam extraction electrodes 14 and 16 are located at the outer periphery of the vacuum vessel housing 5 so that electrode 14 lies closer to the ion source 13 than the other electrode 16.

As will be known to those skilled in the art, the pair of DEE electrode 9, the dummy electrode 11, the ion source 13 and a single beam extraction electrode are commercially available components often found in a cyclotron. However, as an important distinction between the cyclotron 1 of this invention and conventional cyclotrons, a pair of beam extraction electrodes 14 and 16 are located within the vacuum vessel housing 5 and utilized with the ion source 13 for a unique purpose that will be described in greater detail hereinafter.

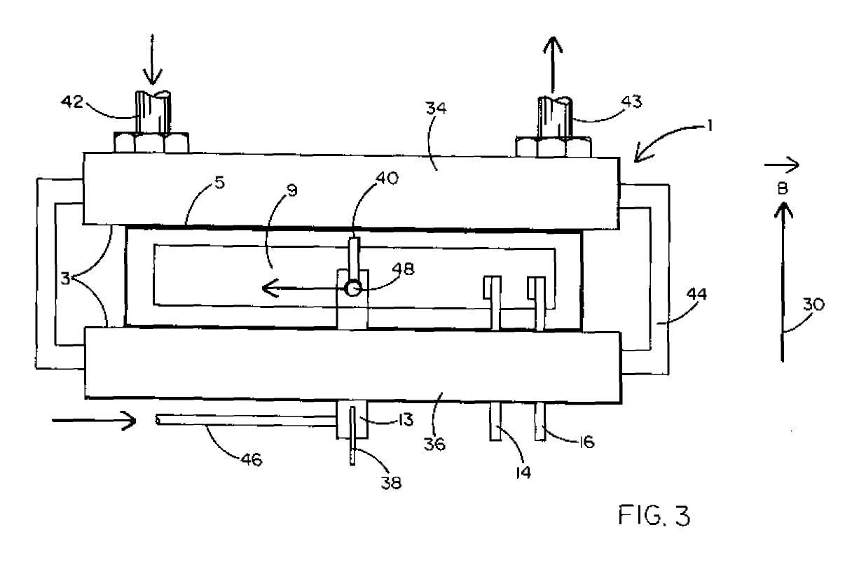

A magnetic field produced by a pair of superconducting solenoid coils (34 and 36 of FIG. 3) penetrates the housing 5 so that a revolving stream of ionized deuterium gas 20 is generated to fill the vacuum vessel housing 5. Deuterons orbit in an expanding helical path around the ion source 13 and towards the beam extraction electrodes 14 and 16. It will be appreciated that the energy of the deuterons increases along their helical orbit as the gas stream 20 moves closer to the extraction electrodes 14 and 16 at the periphery of the vacuum vessel housing 5.

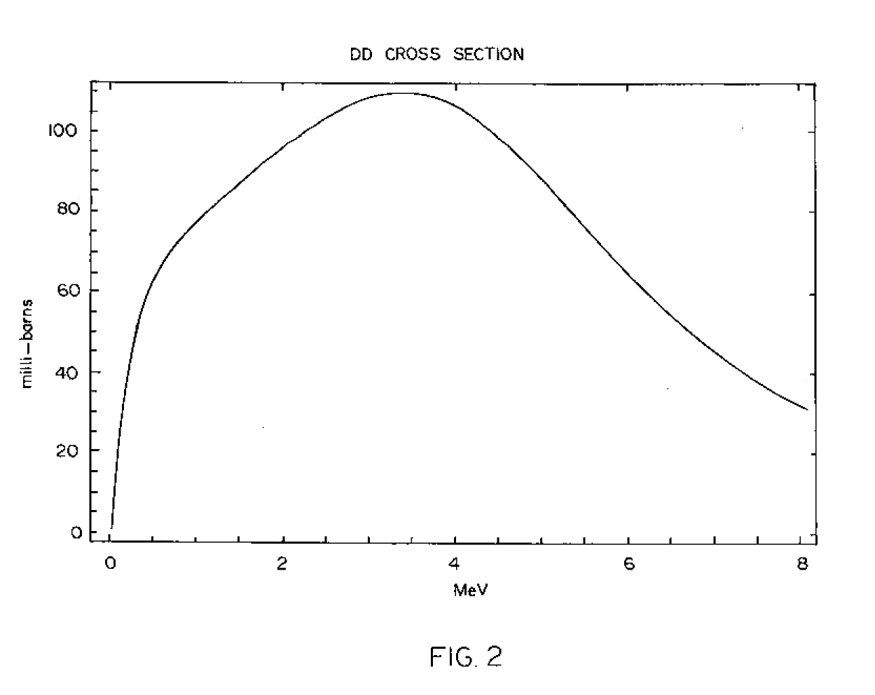

The extraction electrodes 14 and 16 are charged to different high negative voltages so that the energy across the electrode gap 18 remains constant. The gap distance between the electrodes 14 and 16 is carefully designed to extract beams separated in energy by up to 3.5 MeV. This energy difference is chosen to coincide with the maximum DD fusion reaction cross-section as shown in FIG. 2 of the drawings (plotted from the NRL Plasma Handbook), whereby to maximize neutron production. The DD cross-section peak of 3.5 MeV is nearly 10 times greater than the DD cross-section at 100 KeV. For colliding beams with 100 KeV or more relative energy, good reaction rates are possible.

An (e.g., stainless steel) extraction port 22 runs from inside the vacuum vessel housing 5 at a location adjacent the beam extraction electrodes 14 and 16 to a (e.g., stainless steel) vacuum flange 24 lying outside the housing 5. The vacuum flange 24 is elongated so as to be coupled to a corresponding vacuum flange from a superconducting beam focusing tube (designated 50 in FIG. 3) to enable the extraction port 22 from the vacuum vessel housing 5 of cyclotron 1 to communicate with the beam focusing tube 50.

By virtue of the cyclotron 1 employing the pair of high voltage, negatively-charged beam extraction electrodes 14 and 16, a pair of deuteron beams 26 and 28 are deflected away from the revolving stream of deuteron gas 20 and outwardly from the vacuum vessel housing 5 through the extraction port 22. The first deuteron beam 26 deflected by electrode 14 will have a lower energy than and travel through the extraction port 22 ahead of the second beam 28. However, the second deuteron beam 28 deflected by electrode 16 will have a greater energy and travel at a higher velocity than the energy and velocity of the first beam 26. The significance of extracting a pair of staggered deuteron beams 26 and 28 having different energies, velocities and origination times for the purpose of generating high intensity, high energy neutron beams will soon be explained.

FIG. 3 of the drawings is a side view of the superconducting cyclotron 1 shown in FIG. 1, The direction of the operating magnetic field is represented by reference arrow 30. The superconducting coil cryostat 3 is shown having a pair of solenoid coils 34 and 36 spaced one above the other to be energized to produce the operating magnetic field. The cyclotron vacuum vessel housing 5 is situated between the coils 34 and 36 of coil cryostat 3. The single DEE electrode 9 is shown surrounded by the vacuum vessel housing 5. The (Penning) ion source 13 is shown at the center of and coaxially aligned with the vacuum vessel housing 5 to generate the revolving ionized deuterium gas stream (designated 20 in FIG. 1) in a helical path extending outwardly towards the pair of high voltage extraction electrodes 14 and 16. To this end, the ion source 13 includes a high voltage cathode 38 at one end thereof and a passive cathode 40 at the opposite end.

A coolant feed-in 42 and a vent 43 carry a cryogenic coolant such as liquid nitrogen lo and from the pair of solenoid coils 34 and 36. The feed-in 42 and vent 43 communicate with a coolant connection tube 44 which runs between the solenoid coils and encircles the coil cryostat 3 so that a coolant can be continuously circulated through the solenoid coils.

A gas inlet tube 46 supplies the gas to be ionized to the ion source 13. A gas exit port 48 communicates with the ion source 13 so that the stream of ionized gas may be delivered first to the innermost beam extraction electrode 14 (relative to ion source 13) and then to the outermost beam extraction electrode 16, whereby the pair of deuteron beams (26 and 28 in FIG. 1) can be deflected from the revolving gas stream as previously described and extracted through the extraction port 22 to the superconducting beam focusing tube 50.

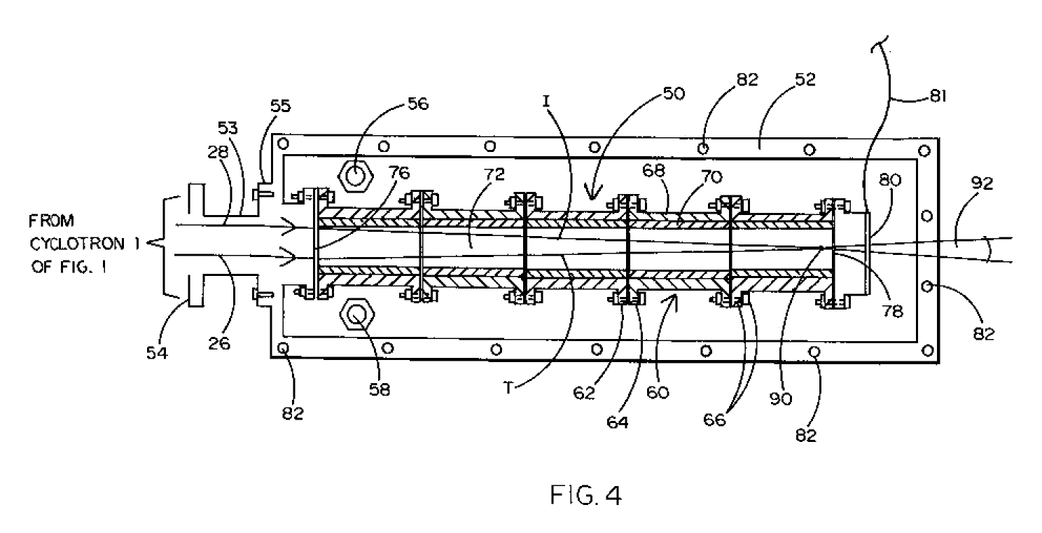

Turning in this regard to FIG. 4 of the drawings, details are now disclosed of the superconducting beam focusing tube 50 according to a preferred embodiment that is coupled to the cyclotron 1 of FIGS. 1 and 2 for producing a high intensity, high energy neutron beam. The beam focusing tube 50 is surrounded and enclosed by a cryostat vacuum container 52 having a (e.g., stainless steel) vacuum flange 54 at one end thereof to be mated to the opposing vacuum flange (24 in FIG. 1) from the extraction port 22 of the cyclotron 1 to permit the extraction port 22 to communicate with the beam focusing tube 50 by way of an (e.g., aluminum) tubular entry port 53 and an (e.g., aluminum) coupling head 55 at one end of the cryostat vacuum container 52. Thus, the pair of deuteron beams 26 and 28 that are extracted from the cyclotron 1 are fed into and tunneled through the superconducting beam focusing tube 50 within which to collide with one another. A feed-in 56 and a vent 58 communicate with the interior of the cryostat vacuum container 52 which surrounds the beam focusing tube 50 so that a coolant such as liquid nitrogen can be continuously carried to, circulated through, and removed from container 52.

The superconducting beam focusing tube 50 is preferably assembled from a series of hollow, double-walled tube sections (e.g., 60) that are connected end-to-end one another by opposing vacuum-sealed flanges 62 and 64 that are held together by means of (e.g., stainless steel) nut and bolt combinations 66. Each hollow tube section 60 includes a thermally-conductive (e.g., copper) outer wall 68 that surrounds a superconducting inner wall 70. The inner wall 70 of each tube section 60 is manufactured from a known high temperature superconducting material such as YBCO or the like. With the hollow tube sections 60 connected end-to-end, a beam transmitting and collision path 72 is established through the superconducting beam focusing tube 50. Like the interior of the vacuum vessel housing 5 of the cyclotron 1 of FIGS. 1 and 2, the beam transmitting and collision path 72 through tube 50 is maintained at a vacuum.

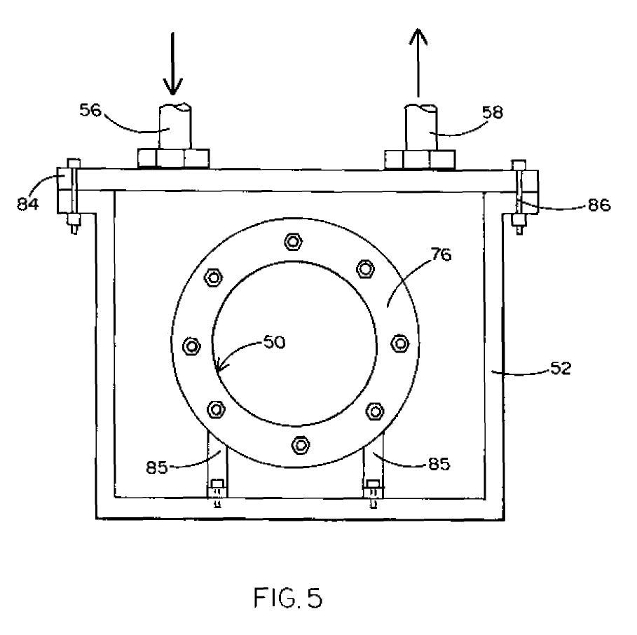

A thermal sealing ring 76 is located at one end of the beam focusing tube 50 in front of the coupling head 55. An insulator ring 78 is located at the opposite end of the beam focusing tube 50. A beam dump 80 (i.e., cathode) which is manufactured from aluminum, or the like, is spaced in front of the beam focusing tube 50. A wire 81 runs through the cryostat vacuum container 52 to hold the beam dump 80 to a negative potential. FIG. 4 shows a series of mounting holes 82 spaced around the top of the cryostat vacuum container 52 to receive respective fasteners by which to connect a cover 84 over top the container 52 (best shown in FIG. 5).

Turning briefly to FIG. 5 of the drawings, a side view is shown of the cryostat vacuum container 52 surrounding and enclosing the superconducting beam focusing tube 50. As previously described, the beam focusing tube 50 is immersed in a coolant (e.g., liquid nitrogen) that is continuously supplied to and removed from the interior of container 52 by a feed-in 56 and a vent 58 through the top cover 84 of container 52. The beam focusing tube 50 is held above the bottom of the cryostat vacuum container by (e.g., copper) floor mounts 85. Fasteners such as bolts 86 are used to secure the top cover 84 to the container 52. The bolts 52 extend through cover 84 for receipt by respective mounting holes (82 of FIG. 4) in the container 52.

Returning to FIG. 4, the pair of deuteron beams 26 and 28 which have been extracted from the cyclotron 1 are shown being funneled through the vacuum inside the superconducting inner wall 70 of the beam focusing tube 50. As previously described, the target deuteron beam 26 (also designated T) is extracted from the cyclotron 1 prior to the incident deuteron beam 28 (also designated I). However, the incident deuteron beam 28 has a greater energy and travels at a higher velocity than target beam 26. Therefore, although the deuteron beams 26 and 28 are staggered in time and energy, the faster traveling incident beam 28 will catch up to and collide with the slower traveling target beam 26 at a collision point 90 within the superconducting beam focusing tube 50. That is to say, the superconducting inner wall 70 causes the staggered beams 26 and 28 to be pushed towards one another, such that the beam focusing tube 50 functions as a lens.

Focusing the staggered beams 26 and 28 is a result of the Meissner effect by which the superconductor of tube 50 repels the magnetic fields generated by the passing beams 26 and 28, thus causing the beams to move towards the longitudinal tube axis. As in most colliding beam machines, luminosity is a problem, such that substantial focusing of the deuteron beams 26 and 28 is required. The apparatus herein disclosed accomplishes the beam focusing by means of the superconducting beam focusing tube 50.

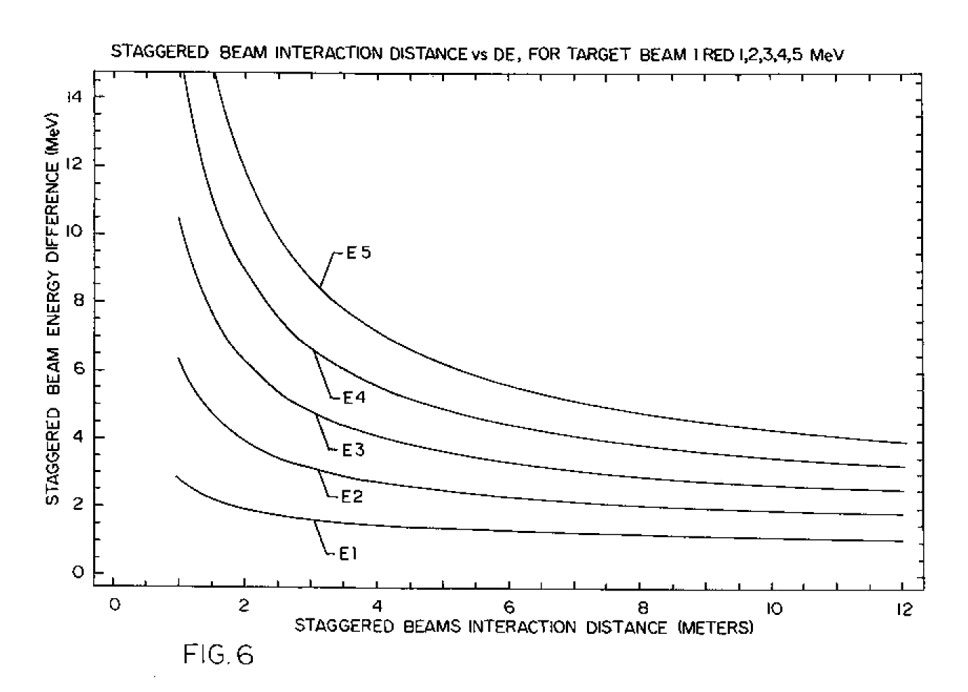

The energy difference between the deuteron beams 26 and 28 prior to collision is constant (e.g., 3.5 MeV) as previously described. It is preferable that the collision point 90 occur close to the end of the beam focusing tube 50 adjacent which the beam dump 80 is located. Turning briefly in this regard to FIG. 6 of the drawings, a graphical representation is illustrated of the interaction (i.e., collision) distances from the extraction port 22 of the cyclotron 1 of FIG. 1 for staggered incident and target beams traveling down the superconducting beam focusing tube 50. Each curve represents a fixed target beam energy: at 1.0 MeV for curve E1; at 2.0 MeV for curve E2; at 3.0 MeV for curve E3; at 4.0 MeV at curve E4; and at 5.0 MeV for curve E5. As the energy difference between the colliding beams increases (vertical axis), the interaction distance is shortened. For the 3.0 MeV (E3) target beam, an incident beam of about 6.0 MeV will interact about 2.0 meters from the extraction port 22.

Returning once again to FIG. 4, it may be appreciated that at the point 90 or collision, the target beam 26 and the incident beam 28 which chases the target beam are traveling in the same (i.e., forward) direction through the superconducting beam focusing tube 50 to produce a high fluence of neutrons (for example, about 1×10⁸ neutrons/second). More particularly, at the collision point 90, the reaction D(D,n) ³He occurs and neutrons are produced. By virtue of the foregoing, the output energy (8 MeV or greater) of the resultant neutron beam 92 generated following collision will be maximized. That is, the neutron beam 92 will retain most of the forward momentum and energy of both the incident and target deuteron beams 26 and 28 to produce an energetic neutron beam 92 having a narrow beam profile. In this same regard, co-linear scattering in the forward direction is achieved by the resultant neutron beam 92 as opposed to little or no forward scattering when (as is common to conventional neutron generating techniques) an incident beam collides with a stationary target or where incident and target beams traveling in opposite directions strike each other bead on.

It is desirable that the point of collision 90 occur near the end of the superconducting tube 50 adjacent the cathode beam dump 80 to avoid neutrons and protons colliding in the middle of the tube. Because of the aforementioned co-directional beams and co-linear scattering in the same forward direction, the resultant neutron beam 92 will have a relatively narrow width (e.g., making an angle of about 22 degrees at 8 MeV) as the neutrons emerge from tube 50. As the neutron beam 92 passes outwardly from the beam focusing tube 50 and through the cryostat vacuum container 52, protons and residue particles (e.g., tritium, ³He) generated during the collision of the deuteron beams will be collected at the cathode (negative potential) beam dump 80 or by means of a suitable getter located within the beam dump (not shown).

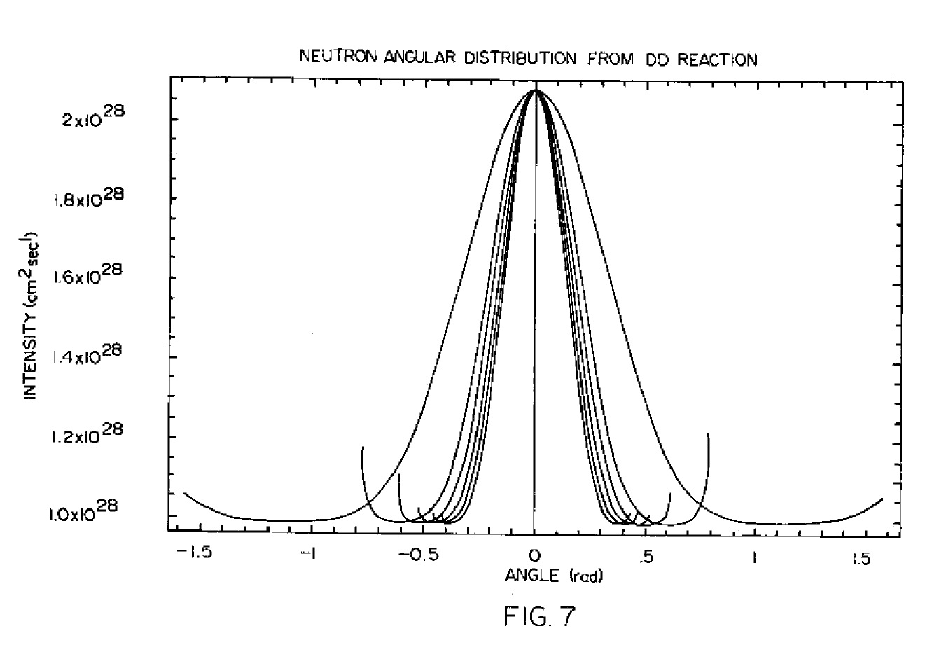

FIG. 7 of the drawings is a graphical representation illustrative of the beam profiles and the neutron angular distribution from a collision of the target and incident deuteron beams (26 and 28) with 2.0 MeV relative energy. The widest (i.e., outermost) beam shown in FIG. 6 is a center of mass beam with a 0 MeV boost and a neutron beam width taken as full-width at half maximum (FWHM) of 44.8 degrees. The narrowest (i.e., innermost) beam shown in FIG. 6 corresponds to a 12 MeV boost and an FWHM of 18.9 degrees. It may be appreciated from FIG. 6 that the greatest distribution of neutrons occurs at the center of each curve. Moreover, the greater the speed of the neutron beam and the larger the MeV boost, the narrower will be the corresponding beam width profile.

The superconducting neutron source of the present invention has several advantages over conventional neutron generating techniques. That is, the neutron source can be made portable. Different neutron energies and intensities can be produced, limited only by the colliding deuteron beam energies and beam current. As a significant advantage, neutrons can be produced in a relatively narrow beam with high intensity. Thus, a generated intensity of 1×10⁸ goes to a small solid angle beam profile (e.g., 22 degrees). By contrast, any conventional sources generating this fluence would put 10⁸/4π or approximately 8×106 neutrons in the same 22 degree beam, resulting in nearly 100 times less neutrons.

The neutron beam source herein disclosed has a variety of applications. By way of example only, a narrow neutron beam (92 of FIG. 4) can be used in the medical field for cancer therapy while minimizing damage to healthy tissue. A narrow neutron beam can also be used for the detection of explosives. What is more, narrow neutron beams can be applied from a portable source in the inspection of infrastructures such as pillars and bridges to detect cracks as a consequence of age and fatigue.

1. A method for producing neutrons, said method comprising the steps of:
generating a first deuteron beam at a first energy and traveling in a first direction;
generating a second deuteron beam at a different energy and traveling in said first direction;
causing said first and second deuteron beams to collide with one another to produce said neutrons traveling in said first direction.

2. The method recited in claim 1, comprising the additional step of generating said second deuteron beam with a greater velocity and a higher energy than the velocity and energy of said first deuteron beam.

3. The method recited in claim 2, comprising the additional step of generating said first deuteron beam prior to the step or generating said second deuteron beam.

4. The method recited in claim 2, comprising the additional steps of generating said first and second deuteron beams by supplying a stream of ionized deuterium gas from an ion source to a pair of beam extraction electrodes; and locating a first of the beam extraction electrodes closer to the ion source than the other beam extraction electrode, such that the first deuteron beam is deflected from said gas stream by said first extraction beam electrode and the second deuteron beam is deflected from said gas stream by the other beam extraction electrode, said first deuteron beam being produced before said second deuteron beam, whereby said first and second deuteron beams are staggered in time relative to one another.

5. The method recited in claim 4, comprising the additional steps of locating said ion source and said pair of beam extraction electrodes inside a vacuum housing of a cyclotron; and extracting said first and second deuteron beams from said vacuum housing by way of an extraction port formed in said vacuum housing.

6. The method recited in claim 5, comprising the additional step of tunneling said first and second deuteron beams extracted by way of the extraction port of the vacuum housing of said cyclotron through a beam focusing tube containing a vacuum wherein said deuteron beams collide with one another and produce said neutrons.

7. The method recited in claim 6, comprising the additional step of manufacturing said beam focusing tube to include a wall made from a superconducting material for causing said first and second deuteron beams to move towards and collide with one another within said beam focusing tube.

8. The method recited in claim 7, comprising the additional steps of manufacturing said beam focusing tube to also include a wall made from heat-conducting material; and surrounding said wall made from superconducting material by said wall made from heat-conducting material.

9. The method recited in claim 7, including the additional step of manufacturing said beam focusing tube from a plurality of sections; and connecting said plurality of sections end-to-end one another by means of opposing vacuum seal flanges and metal fasteners extending between adjacent ones of said flanges.

10. The method recited in claim 7, including the additional steps of locating a cathode beam dump adjacent said beam focusing tube; and charging said cathode beam dump to a negative potential in order to trap protons generated as a result of the collision of said first and second deuteron beams within said tube.

11. The method recited in claim 10, comprising the additional step of charging said pair of beam extraction electrodes to different negative potentials for causing said first and second deuteron beams to collide with one another at a location within said beam focusing tube that lies closer to said cathode beam dump than to the extraction port of the vacuum housing of said cyclotron.

12. The method recited in claim 7, including the additional steps of locating said beam focusing tube within a container that is filled with a liquid coolant; and continuously circulating said liquid coolant into and out of said container.

13. A method for producing neutrons, said method comprising the steps of:
locating a pair of beam extraction electrodes within a vacuum chamber of a cyclotron;
filling the vacuum chamber of said cyclotron with an ionized deuterium gas;
charging said pair of beam extraction electrodes to different negative potentials, such that a first deuteron beam is generated from the ionized deuterium gas at a first energy by said first beam extraction electrode and a second deuteron beam is generated from the ionized deuterium gas at a second energy by said second beam extraction electrode; and
tunneling said first and second deuteron beams through a beam focusing tube manufactured from a superconducting material for causing said beams to collide with one another within said tube and thereby produce said neutrons.

14. The method recited in claim 13, comprising the additional step of extracting said first and second deuteron beams from the vacuum chamber of said cyclotron such that said beams are funneled in the same direction through said beam focusing tube to collide with one another within said tube.

15. The method recited in claim 14, wherein said first deuteron beam is extracted from the vacuum chamber of said cyclotron ahead of said second deuteron beam, said second deuteron beam having a higher energy and a greater velocity through said beam focusing tube than said first deuteron beam.

16. The method recited in claim 15, wherein said first and second deuteron beams are staggered from one another and focused by said beam focusing tube manufactured from said superconducting material, such that said first and second deuteron beams collide with one another at a particular location within said beam focusing tube and with an energy sufficient to produce a narrow neutron beam with the forward momentum of said colliding deuteron beams.

17. Apparatus for producing neutrons, comprising:
a cyclotron including a vacuum chamber, a source of ionized deuterium gas by which to fill said vacuum chamber with said deuterium gas, and a pair of beam extraction electrodes within said vacuum chamber to be charged to generate from said ionized deuterium gas first and second deuteron beams; and
a beam focusing tube manufactured from a superconducting material to receive the first and second deuteron beams from the vacuum chamber of said cyclotron, whereby said deuteron beams are caused to move towards one another and collide within said beam focusing tube to thereby produce said neutrons.

18. The apparatus recited in claim 16, wherein each of said pair of beam extraction electrodes is charged to a negative potential, said first beam extraction electrode generating said first deuteron beam and the other beam extraction electrode generating said second deuteron beam, said second deuteron beam having a higher energy and a greater velocity through said beam focusing tube than said first deuteron beam.

19. The apparatus recited in claim 17, wherein said pair of beam extraction electrodes are spaced from one another such that there is an energy difference therebetween, said energy difference being selected to correspond to the collision energy at which neutron production is at a peak, said first beam extraction electrode being located closer to said source of ionised deuterium gas than the other beam extraction electrode, whereby said first deuteron beam is generated prior to and received by said beam focusing tube ahead of said second deuteron beam.

20. The apparatus recited in claim 17, further comprising a cathode beam dump adjacent said beam focusing tube, said cathode beam dump being charged to a negative potential to trap protons generated as a result of the collision of said first and second deuteron beams within said tube.

21. The apparatus recited in claim 19, wherein said pair of beam extraction electrodes are charged so as to cause said first and second deuteron beams to collide with one another within said beam focusing tube at a point located closer to said cathode beam dump than to said cyclotron.
